(19) United States
(12) Patent Application Publication
(10) Pub. No.: US 2024/0246077 A1
(43) Pub. Date: Jul. 25, 2024

(54) PROCESS AND RECEIVING SPACE FOR OPTICALLY RECORDING MICROPARTICLES AND USING A MOVING COMPONENT TO REMOVE A COVER ELEMENT BEFORE RECORDING

(71) Applicant: Testo bioAnalytics GmbH, Titisee-Neustadt (DE)

(72) Inventor: Markus Munzer, Hinterzarten (DE)

(73) Assignee: Testo bioAnalytics GmbH, Titisee-Neustadt (DE)

(21) Appl. No.: 18/413,186

(22) Filed: Jan. 16, 2024

(30) Foreign Application Priority Data
Jan. 20, 2023 (DE) 102023101477.3

(51) Int. Cl. B01L 3/00

(52) U.S. Cl. CPC B01L 3/502753; B01L 3/502715; B01L 2200/0647; B01L 2300/0654; B01L 2300/0681; B01L 2400/0409

(57) ABSTRACT

A process for recording microparticles (1) in a receiving space (3) is provided, with the microparticles (1), preferably in a fluid (4), being transferred into the outwardly closed receiving space (3) prior to the optical recording, and the receiving space (3) being outwardly opened prior to the recording. Such a process and receiving space (3) are of interest in particular for the recording and analysis of microparticles (1) in pharmacy and the foodstuff industry, but are not restricted to these sectors of industry.

### CROSS-REFERENCE TO RELATED APPLICATIONS

This application claims priority to German Patent Application No. 10 2023 101 477.3, filed Jan. 20, 2023, which is incorporated herein by reference as if fully set forth.

### TECHNICAL FIELD

The invention relates to a process for the optical recording of microparticles in a receiving space, where the microparticles, preferably in a fluid, are transferred into the outwardly closed receiving space prior to the optical recording.

The invention also relates to a receiving space, in particular of a microfluidic system, for the optical recording of microparticles on a membrane.

The invention also relates to the use of a rotatable and/or pivotable movement component for removing a cover element prior to a recording.

### BACKGROUND

Processes and receiving spaces for the recording of microparticles are known and are often used in diagnostics, preferably in the foodstuff industry, in pharmaceutical production and in medicine. In the case of known processes, microparticles are often transferred to and collected on a membrane, which is in the receiving space, in a fluid. The receiving spaces are usually covered and sealed off by a transparent cover element. If it is necessary to detect weak microparticles during the recording, for example in the course of fluorescence measurements, complex and time-intensive corrections must be made owing to the cover element. A cover element between the detector and the microparticles thus has an adverse effect on the optimum analysis of an environmental sample and can even have the effect that it is not possible to detect less-abundant microparticles at all.

### SUMMARY

An object of the invention is therefore to improve the recording of microparticles.

One or more of the features disclosed herein are provided according to the invention in order to achieve the stated object. In particular, in order to achieve the stated object in the case of a process of the type described at the outset, the invention therefore proposes that the receiving space is outwardly opened prior to the recording. Therefore, a recording can be taken without a cover element, which otherwise would be positioned between the microparticles located in the receiving space and a detector. This makes it possible to reduce or even avoid complex and time-intensive corrections. In general, particularly weak signals and/or less-abundant microparticles can be recorded through the opening of the receiving space to the outside and this is advantageous, in particular in the case of fluorescence measurements. It is therefore possible to improve the recording of microparticles by a process according to the invention.

A (non-exhaustive) list of microparticles may, for example, include: living or organic matter, in particular microorganisms such as bacteria, fungi and protozoa, and viruses and parts thereof, and dead or inorganic matter, for example dust particles and/or carbon black particles.

In the case of a process according to the invention, the receiving space can be reversibly outwardly opened or permanently opened, as a result of which a process can be flexibly adapted to the given conditions, or desires of the user.

When the microparticles are being transferred into the receiving space, the latter is closed, so that the microparticles and/or the fluid cannot get out, and therefore the elements, such as a detector, located outside the receiving space are not acted on or damaged. This makes it possible, in the case of a process according to the invention, to realize a more secure feed of the microparticles into the receiving space together with optimized detection of the microparticles, as a result of which a recording of the microparticles can be particularly improved.

An advantageous embodiment of the process can provide that the receiving space is filled with the fluid for the purpose of transferring the microparticles. This makes it possible to transfer a particularly high number of microparticles into the receiving space and record them. The microparticles can also be protected or kept in the fluid such that a recording is improved. It is possible to provide that the microparticles in the fluid are transferred in a pretreated state and/or are (further) pretreated in the receiving space, before a recording is performed.

It is possible to provide in particular that a cover element of the receiving space is at least partially wetted by the fluid. In this respect, it is advantageously possible for a volume of the receiving space to be optimally filled with the fluid, with the result that a recording of as far as possible all the microparticles of an environmental sample under investigation is enabled.

An advantageous embodiment of the process can provide that the fluid in the receiving space is removed prior to the opening.

This makes it possible to prevent fluid getting out of the receiving space through the opening and sensitive apparatuses, such as a detector, being damaged. It is thus possible to put a process into effect repeatably and in long-lasting fashion.

An advantageous embodiment of the process can provide that at least one movement component of the opening movement is carried out along an opening closed by the cover element. This makes it possible to ensure advantageously that the cover element is moved or movable completely off of the opening, or at least far enough off of the opening that a recording can be performed.

As an alternative or additionally, it is possible to provide that the opening at a, preferably the already mentioned, cover element is opened in automated fashion. As a result, it can be advantageous to use an opening mechanism to move the cover element in automated fashion, and therefore manual engagement is no longer necessary. This makes it possible to protect a user or the microparticles under investigation.

An advantageous embodiment of the process can provide that the at least one movement component is carried out outside the receiving space. It is therefore possible to outwardly open the receiving space without the at least one movement component being realized inside the receiving space. It is thus possible in particular to produce an opening mechanism and/or a gripping element such that it does not project into or beyond the opening at least during an opening movement. This makes it possible to advantageously prevent the receiving space from becoming contaminated, for example by abrasion, during the opening. Similarly, the receiving space can have a space-saving design, since the at least one movement component is carried out outside, this improving the process.

The movement component can preferably move about an axis of rotation. The cover element can therefore perform an opening movement without reaching into or entering the space outside the receiving space. This makes it possible to position or move a component, for example a detector, outside the receiving space, and this is advantageous.

An advantageous embodiment of the process can provide that a second movement component acts on the first movement component and preferably sets the first movement component in a rotational movement. Here, the second movement component can advantageously act on the first movement component, in order to remove the cover element. As a result, removal of the cover element can be particularly finely coordinated and/or controllable.

In particular, it is possible to provide in this case that the second movement component preferably moves about a second axis of rotation. It is therefore advantageously possible to use a rotational movement in order for the first movement component to serve as an impulse for removal of the cover element.

As an alternative or additionally, the first and the second movement component can preferably move in oppositely directed rotational movements. This makes it possible to decouple a point of action of the first and the second movement component, so that an opening movement of the cover element can be paused and/or stopped.

An advantageous embodiment of the process can provide that at least one movement component preferably carries out a pulling movement, in order to remove a cover element, which is in the form of a preferably self-adhesive covering film, from the opening. This makes it possible advantageously to pull a cover element, preferably a covering film, off of the opening.

An advantageous embodiment of the process can provide that the process is carried out in a fluidic channel system. This makes it possible to carry out a process with a small volume, as a result of which a cover element can have a relatively small and inexpensive design.

In particular, the process can be carried out in a microfluidic system. This makes it possible to make a microenvironment of the microfluidic system controllable, as a result of which various processing and/or detection procedures of the process can be carried out quickly and inexpensively.

As an alternative or additionally, the features of the additional independent claim, directed at a receiving space, are provided according to the invention to achieve the stated object. In particular, in order to achieve the stated object in the case of a receiving space of the type described at the outset, the invention therefore proposes that the receiving space is closed by a removable cover element. A removable cover element can be understood to mean a cover element which is removed from the receiving space in the long term at least during a recording. Advantageously, in the case of a removable cover element, it may in any case be true that the receiving space can be closed and sealed off by the cover element when a fluid is being transferred. In addition, a removable cover element makes it possible to improve a recording of microparticles to the effect that the cover element is non-disruptively positioned between the microparticles and a detector.

In particular, a removable cover element can outwardly open a receiving space according to a process that is described above or claimed below. Particularly versatile and advantageous use can therefore be made of a receiving space in order to record microparticles.

The removable cover element is preferably designed such that devices, for example a detector, are not adversely affected by removing the cover element in order to open the receiving space, and this is advantageous. A receiving space can therefore be adapted to a detection area in order preferably to be able to carry out a process according to the invention.

An alternative embodiment can provide that the cover element is in the form of a preferably self-adhesive covering film. In this case, the composition and/or the adhesive strength of the covering film can be adapted to a material of the receiving space, so that the covering film closes and seals off the receiving space. Another advantage resulting from a self-adhesive covering film is a relatively thin design, with the result that space can be saved to the outside.

The self-adhesive covering film may in particular be in the form of a loop. This makes it possible to reduce a pull-off force for removing the self-adhesive covering film to a minimum. This is advantageous in particular when the covering film is removed from the opening preferably by a pulling movement, for example carried out by a rotatable and/or pivotable arm.

An alternative embodiment can provide that the cover element is made of a transparent material at least in the area of an opening of the receiving space. It is therefore possible to carry out, for example, a “pre-screening”, in order to record the procedure of transferring the microparticles into the receiving space. The microparticles of a valuable environmental sample can furthermore also be recorded if the removal of the cover element is erroneous and/or insufficient, and this is advantageous.

An alternative embodiment can provide that the opening is as large as a provision area in which the microparticles can be provided. As a result, in the event of a recording it is possible to record all the microparticles that are in the provision area at the same time through the opening, and therefore the recording can be performed particularly quickly.

An alternative embodiment can provide that the cover element is temporarily or permanently fastened to a gripping element. Temporarily fastening the cover element to the gripping element makes it possible to remove the cover element by way of a movement of the gripping element, so that the receiving space is advantageously outwardly opened. In the case of permanent fastening, an additional advantage can be that the cover element can alternatively or additionally be fastened to the receiving space via the gripping arm.

In particular, the cover element can be temporarily or permanently fastened to a rotatable and/or pivotable arm. The cover element can therefore be removed from the opening by a rotational and/or pivoting movement, this being advantageous in particular for the removal of a covering film, as described above or claimed below.

An alternative embodiment can provide that the gripping element preferably completely covers the cover element. The gripping element can therefore protect the cover element at least partially, but in particular completely, against damage, this being advantageous in particular in the case of a covering film as described above or claimed below.

An alternative embodiment can provide that a movable device can at least temporarily act on the gripping element to remove the cover element. A movable device can therefore advantageously act on the gripping element in order to remove the cover element. In this case, the movable element may be movable in various degrees of freedom, in order to ensure a particularly versatile functionality.

In particular, it is possible to provide that a point of action is designed to transfer a torque of the movable device to the gripping element. The movable element can therefore be suitable particularly advantageously for carrying out a process in which, as already described above and as claimed below, a second movement component acts on a first movement component.

An alternative embodiment can provide that the receiving space has an inflow and/or outflow.

This is advantageous in particular when the microparticles are transferred to the membrane in a fluid. Thus, a fluid can enter the receiving space via the inflow and be transferred to the membrane. The outflow may be designed to remove excess fluid or to convey the fluid on.

The membrane is preferably positioned between the inflow and the outflow. In this case, the membrane is preferably arranged below the inflow and above the outflow, as a result of which advantageously fluid can drip into the outflow and leave the receiving space. Overall, it is thus possible to make a receiving space particularly variable by virtue of an inflow and/or outflow and to carry out a wide variety of processes, as described above and/or claimed below.

An alternative embodiment can provide that the inflow leads into the receiving space at a spacing from the cover element. This makes it possible to avoid the cover element being wetted when a fluid is fed to the receiving space. It can be advantageous if, when the cover element is removed, no fluid reaches the outside, as a result of which soiling and/or contamination outside the receiving space can be reduced or prevented.

An alternative embodiment can provide that the receiving space is wider between the inflow and the outflow. A recording surface area can therefore be larger than a transverse transport surface area of the microparticles, this being advantageous in particular when microparticles are collected in the receiving space. In the case of a wider receiving space, it is thus possible specifically to collect a particularly high number of, or even all, the microparticles of an environmental sample, as a result of which a recording can be particularly accurate.

An alternative embodiment can provide that the receiving space comprises a ventilation structure, which projects at least partially outside the opening. The receiving space can therefore be ventilated and relieved of pressure, this being particularly advantageous in the case of a receiving space which is in the form of part of a microfluidic system as described and/or claimed below.

The ventilation structure preferably projects in a different plane to the opening. A fluid can therefore be prevented from overflowing out of the receiving space, in particular if an outlet of the ventilation structure is positioned above an inflow of the receiving space.

In particular, it is possible to provide that the ventilation structure can be closed by the cover element. The ventilation structure can therefore advantageously be closed by the removable cover element.

An alternative embodiment can provide that the receiving space is in a fluidic channel system. Small sample volumes of an environmental sample can therefore be analyzed.

In this case, the receiving space can in particular be in the form of part of a microfluidic system, with the microfluidic system preferably being in the form of part of a disk-shaped sample carrier. A small volume can therefore be quickly implemented in automated fashion to record microparticles in a process, in particular as described above or claimed below.

A disk-shaped sample carrier can also be designed for centrifugation. This makes it possible to automate the recording of microparticles particularly advantageously using centrifugal microfluidics, and this is very advantageous.

As an alternative or additionally, one or more of the features disclosed herein, directed at a use, are provided according to the invention to achieve the stated object.

In particular, in order to achieve the stated object in the case of a use of the type described at the outset, the invention therefore proposes that the rotatable and/or pivotable movement component is preferably used in a receiving space as described above or claimed below, and/or in a process, as described above or claimed below, for removing a cover element prior to a recording. A rotatable and/or pivotable movement component advantageously allows a cover element to outwardly open a receiving space, without the cover element reaching or being guided into the space outside the receiving space during the opening movement. This can be advantageous in particular when the receiving space is part of a detection area, since the space outside the receiving space can therefore be free for the positioning of other components, for example at least one detector.

### BRIEF DESCRIPTION OF THE DRAWINGS

The invention will now be described in more detail on the basis of exemplary embodiments, but is not restricted to these exemplary embodiments. Further exemplary embodiments arise from combining the features of individual or multiple claims with one another and/or with individual or multiple features of the exemplary embodiments.

In the figures:

FIG. 1 shows a side view of a fluidic channel system with a receiving space according to the invention,

FIG. 2 shows a plan view of a receiving space according to the invention with a removable cover element,

FIG. 3 shows a plan view of a receiving space according to the invention with an alternative embodiment of a removable cover element,

FIG. 4 shows a disk-shaped sample carrier with means for carrying out a process according to the invention and a receiving space according to the invention.

### DETAILED DESCRIPTION

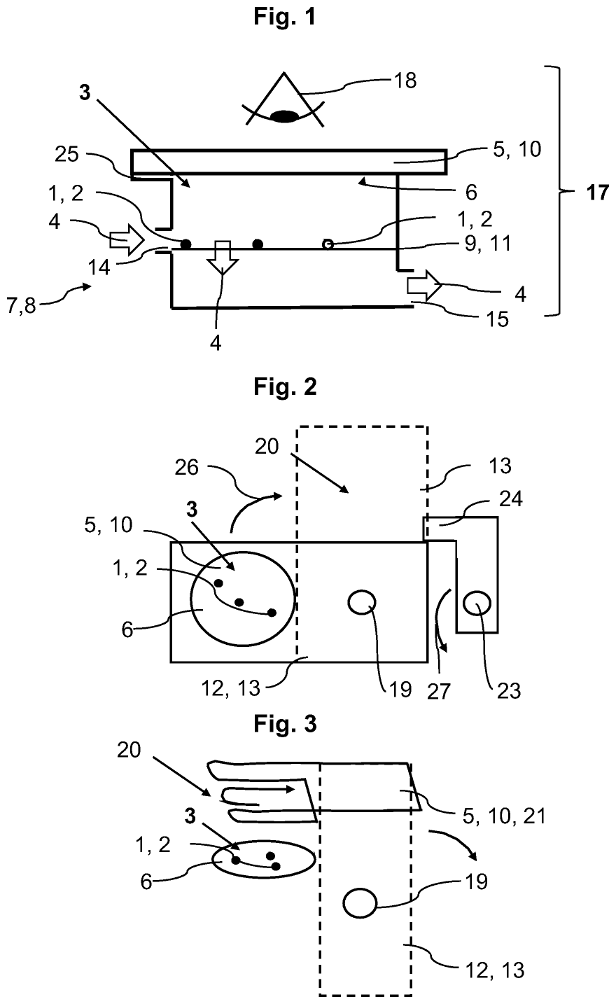

FIG. 1 shows a receiving space 3 according to the invention, which is suitable for carrying out a process, as described above or claimed below, for recording microparticles 1.

The following text describes device features of a receiving space 3 according to the invention and a process that can be carried out therein.

The receiving space 3 is in the form of a constituent part of a microfluidic system 8. It is also possible for the receiving space 3 to be designed for recording microparticles 1 in a fluidic channel system 7 which is not in the form of a microfluidic system 8.

The receiving space 3 in FIG. 1 is closed by a removable cover element 5. Here, the cover element 5 may be in the form of a self-adhesive covering film 10, as illustrated in FIGS. 2 and 3. The covering film 10 illustrated in FIG. 3 is in the form of a loop 21, which advantageously makes it possible to reduce a pull-off force to a minimum. A gripping element 12, such as a rotatable and/or pivotable arm 13, can therefore relatively easily remove the self-adhesive covering film 10 from the opening 6 of the receiving space 3, in order to outwardly open the receiving space 3 prior to the recording.

A cover element 5, 10 may furthermore also, as illustrated at least in FIG. 2, be covered by the gripping element 10, so that the cover element 5, 10 is protected. A receiving space can therefore have a particularly long service life.

The covering film 10 (solid rectangle) of the embodiment shown in FIG. 2 is above the opening 6 of the receiving space 3. A rotational movement of the rotatable arm 13 about an axis of rotation 19 makes it possible to push or transfer the covering film 10 into an open position 20 (three-sided dashed line). Here, as illustrated in FIG. 2, a movable device 24 can act on the rotatable arm. A rotational movement of the movable device 24 about an axis of rotation 23 allows the action to serve as an impulse for the rotatable arm 13, so that the rotatable arm 13 can displace the covering film 10. In this case, the rotatable arm 13 and the movable device 24 preferably rotate in opposite directions (illustrated arrows with the reference signs 26, 27 in FIG. 2), as a result of which a point of action of the rotatable arm 13 and the movable device 24 can advantageously be decoupled.

It is also possible to provide that a cover element 5, like the loop 10, 21 shown in FIG. 3, is detached from the opening 6 and folded into an open position 20 as a result of a pivoting movement of the gripping element 12, 13. A self-adhesive loop 10, 21 can therefore be easily pulled off of the opening 6, as a result of which particularly easy removal of a cover element 5 prior to the recording of the microparticles 1 can be realized.

It is thus possible, as shown in the embodiments of FIGS. 1 to 3, to use a rotatable and/or pivotable movement component to remove a cover element 5 prior to a recording in a receiving space 3. This use preferably happens in the course of a process according to the invention.

The embodiments of FIGS. 2 and 3 also show that at least one movement component of the opening movement is carried out along an opening 6, closed by the cover element 5, of the receiving space 3. Here, the covering films 10 of the embodiments of FIGS. 2 and 3 are permanently connected to a gripping element 12, which can move about an axis of rotation 19 located outside the receiving space 3. A temporary connection of a cover element 5 to a gripping element 12 can, however, also be provided, so that an opening movement can even be reversible.

In general, optimally the gripping element 12 and the cover element 5 can be adapted to one another, in order to remove the cover element 5 from the opening 6 by way of an opening movement.

In addition to a rotational and/or pivoting movement, any movement component known to those skilled in the art can thus be used to outwardly open the cover element 5.

In a process according to the invention, which might proceed as follows, bacteria 2 located in a fluid 4 could be fed to the receiving space 3 via an inflow 14 (cf. FIG. 1). In so doing, the bacteria 2 are collected on a membrane 9 located below the inflow 14, the membrane 9 forming a provision area 11 with a circumference which is as large as the opening 6 of the receiving space 3.

Depending on the volume of the fluid 4, the cover element 5, 10 can be at least partially wetted by the fluid 4, even if the inflow 14 leads into the receiving space 3 at a spacing from the cover element 5, 10 (cf. FIG. 1). While the fluid 4 is transferred into the receiving space 3, the receiving space 3 is sealed off by the cover element 5, 10, so that the fluid 4 cannot pass through the opening 6.

The receiving space 3 is also ventilated by a ventilation device 25, as a result of which the pressure in the receiving space 3 can advantageously be regulated, in particular when the receiving space 3 is being filled. The ventilation device 25 is formed or designed such that no fluid can get out via the ventilation device 25, even when the receiving space 3 is completely filled. The ventilation device 25 can thus project outside the opening 6, for example. In addition, as shown in FIG. 1, the ventilation device 25 is closed by the cover element 5, 10, so that only a ventilation opening can be kept open.

The fluid 4 can be removed from the receiving space 3 via an outflow 15 positioned below the membrane 9, 11, at least prior to the recording.

Since the cover element 5, 10 in FIG. 1 can be transparent at least in the region of the opening 6, a detector 18 located in the detection area 17 could perform a “pre-screening” of the microparticles 1, 2, in order for example to detect the provision of the microparticles 1, 2 on the membrane 9. For this, the cover element 5, 10 could also keep the opening 6 of the receiving space 3 closed. At least prior to the recording of the microparticles 1, 2, the receiving space 3 and the detector 18 are positioned in the detection area 17 on different sides of the removable cover element 5, 10.

To record the microparticles 1, 2, the cover element 5, 10 is outwardly removed, according to the invention, from the opening 6 so that recordings can advantageously be taken without complex and time-intensive corrections. In general, particularly weak signals and/or less-abundant microparticles 1, 2 can be recorded by a detector 18 through the opening 6 of the receiving space 3 to the outside. Specifically, it is possible to provide that the microparticles 1, 2, preferably on the membrane 9, 11, are pretreated by way of at least one processing step, for example fixing and/or conditioning and/or dyeing of the microparticles 1, 2 and/or background reduction and/or thermal and/or optical excitation. This makes it possible specifically for the microparticles 1, 2 to be detectable even if the signal to be detected is relatively weak. A process according to the invention in a receiving space 3 preferably according to the invention therefore makes it possible to improve the recording of microparticles 1, 2 by outwardly opening the cover element 5, 10.

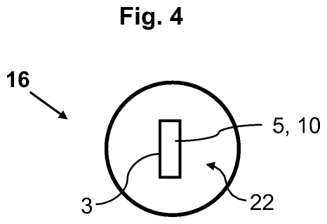

FIG. 4 shows a disk-shaped sample carrier 16 with a microfluidic system 8 as described above, having a receiving space 3 as described above (cf. FIG. 1). The disk-shaped sample carrier 16 can also form further means 22 for carrying out a process as described above or claimed below. The disk-shaped sample carrier 16 in FIG. 4 is suitable for centrifugation, as a result of which it is possible to record microparticles 1, 2 particularly advantageously in automated fashion by virtue of a centrifugal microfluidic system 8.

The invention therefore in general proposes a process in a receiving space 3 for the recording of microparticles 1, the microparticles 1, preferably in a fluid 4, being transferred into the outwardly closed receiving space 3 prior to the optical recording and the receiving space 3 being outwardly opened prior to the recording. Such a process according to the invention and receiving space 3 according to the invention are of interest in particular for the recording and analysis of microparticles 1 in pharmacy and the foodstuff industry, but are not restricted to these sectors of industry.

### LIST OF REFERENCE SIGNS

1 Microparticle
2 Bacteria
3 Receiving space
4 Fluid
5 Cover element
6 Opening of 3
7 Fluidic channel system
8 Microfluidic system
9 Membrane
10 Covering film
11 Provision area for 1, 2
12 Gripping element
13 Rotatable and/or pivotable arm
14 Inflow
15 Outflow
16 Disk-shaped sample carrier
17 Detection area
18 Detector
19 Axis of rotation
20 Opening position
21 Loop
22 Means for carrying out a process according to the invention
23 Second axis of rotation
24 Movable device
25 Ventilation structure
26 Direction of rotation of 12, 13
27 Direction of rotation of 24

1. A process for optical recording of microparticles (1) in a receiving space (3), the process comprising:
transferring the microparticles (1) into the receiving space (3) that is outwardly closed prior to the optical recording; and
outwardly opening the receiving space (3) prior to the optical recording.

2. The process as claimed in claim 1, further comprising filling the receiving space (3) with fluid (4) for the transferring of the microparticles (1), and at least partially wetting a cover element (5) of the receiving space by the fluid (4).

3. The process as claimed in claim 2, further comprising removing the fluid (4) in the receiving space (3) prior to the opening.

4. The process as claimed in claim 2, further comprising at least one of a carrying out at least one movement component of the opening movement along an opening (6) closed by the cover element (5), or carrying out the opening (6) at the cover element (5) in automated fashion.

5. The process as claimed in claim 4, wherein the at least one movement component of the opening movement is carried out outside the receiving space (3), with the at least one movement component moving about an axis of rotation (19).

6. The process as claimed in claim 4, further comprising carrying out a second movement component that acts on the first movement component and sets the first movement component in a rotational movement.

7. The process as claimed in claim 4, wherein the at least one movement component carries out a pulling movement to remove the cover element (5) from the opening (6).

8. The process as claimed in claim 1, wherein the process is carried out in a fluidic channel system (7).

9. A microfluidic system comprising: a receiving space (3) for optical recording of microparticles (1) on a membrane (9); and
a removable cover element (5) that closes the receiving space (3).

10. The system as claimed in claim 9, wherein the cover element (5) comprises a self-adhesive covering film (10).

11. The system as claimed in claim 9, wherein the cover element (5) is made of a transparent material at least in the area of an opening (6) of the receiving space (3).

12. The system as claimed in claim 9, wherein the opening (6) is as large as a provision area (11) in which the microparticles (1) are adapted to be provided.

13. The system as claimed in claim 9, wherein the cover element (5) is temporarily or permanently fastened to a gripping element (12).

14. The system as claimed in claim 13, wherein the gripping element (12) covers the cover element (5).

15. The system as claimed in claim 13, further comprising a movable device (24) that acts at least temporarily on the gripping element (12) to remove the cover element (5).

16. The system as claimed in claim 9, wherein the receiving space (3) has an inflow (14) and an outflow (15), and a membrane (9) is arranged between the inflow (14) and the outflow (15).

17. The system as claimed in claim 16, wherein the inflow (14) leads into the receiving space (3) at a spacing from the cover element (5).

18. The system as claimed in claim 16, wherein the receiving space (3) is wider between the inflow (14) and the outflow (15).

19. The system as claimed in claim 9, wherein the receiving space (3) comprises a ventilation structure (25), which projects at least partially outside the opening (6) and the ventilation structure (25) is closable by the cover element (5).

20. The system as claimed in claim 9, wherein the receiving space (3) is in a fluidic channel system (7), in a disk-shaped sample carrier (16).

21. (canceled)
